(19) United States
(12) Patent Application Publication
(10) Pub. No.: US 2006/0178865 A1
(43) Pub. Date: Aug. 10, 2006

(54) Multilingual user interface for a medical device

(76) Inventors: D. Craig Edwards, Fall City, WA (US); Robert Stanbary, Bellevue, WA (US)

Correspondence Address: MARY Y. REDMAN;MEDTRONIC EMERGENCY RESPONSE SYSTEM INC., P.O. BOX 97006, REDMOND, WA, 98073, US

(21) Appl. No.: 11/263,545

(22) Filed: Oct. 31, 2005

Related U.S. Application Data
(60) Provisional application No. 60/623,192, filed on Oct. 29, 2004.

(51) Int. Cl. G06F 17/20

(52) U.S. Cl. 704/1

(57) ABSTRACT

A medical device includes an audible medium giving user instructions in a first language and a visual medium giving user instructions in a second language. In an embodiment of the invention, the medical device is an external defibrillator with user instructions in an audible medium in a first language and instructions in a visible medium in the second language. In one embodiment, an external defibrillator includes an audio speaker that delivers instructions to the operator in a first language and a visual medium that presents instructions to the operator in a second language. The visual medium may present text instructions in the second language. It may also present pictorial representations of the text instructions in proximity to the text instructions. Alternatively, the visual medium may be a display screen on the external defibrillator. A method for providing a user interface to an operator of a medical device includes providing instructions to the operator audibly in a first language and visually in a second language.

### REFERENCE TO RELATED APPLICATION

This application claims the benefit of U.S. Provisional Application No. 60/623,192 filed on Oct. 29, 2004.

### FIELD OF THE INVENTION

The present invention relates generally to a user interface method and apparatus for a medical device, and more particularly to a user interface method and apparatus for a defibrillator.

### BACKGROUND OF THE INVENTION

Sudden cardiac death is a leading cause of death in the United States. Most sudden cardiac deaths are caused by ventricular fibrillation, in which the heart's muscle fibers contract without coordination, thereby interrupting normal blood flow into the body. The best known effective treatment for ventricular fibrillation is electrical defibrillation, in which an electrical pulse is applied to the patient's heart. The electrical pulse must be delivered within a short time after onset of ventricular fibrillation in order for the patient to have any reasonable chance of survival.

The current trend in the medical industry is to make life-saving portable medical devices, such as automated external defibrillators (AEDs), more widely accessible so that patients in need can be treated as quickly as possible. As the availability of portable medical devices continues to increase, more places will have these devices for use in emergency situations, such as in homes, police cars, worksites, and public gathering places. This increase also comes with the heightened likelihood that these portable medical devices will be used by people without medical training or people who are minimally trained in the handling of the medical devices. At the same time, the benefit of having life-saving medical devices immediately available in many places is not fully realized unless the medical devices can be promptly activated and used quickly in case of emergency. Therefore, a portable medical device, such as an AED, must be configured such that even a lay person can intuitively and quickly activate and use the medical device.

A medical device may automatically instruct an operator how to properly operate the medical device via various user interface components. For example, an AED may include a voice command system, a screen command system, and/or various graphics visible to the operator. To be used effectively, an AED should provide the user with instructions and prompts in the user's primary language. This is particularly important when the medical device is likely to be used by a lay person who is not very familiar with the medical device and thus needs to rely on commands issued by the medical device to properly handle the medical device. In many areas, the population is diverse with respect to languages spoken. For example, in some parts of the United States, a portion of the population uses only the English language; another uses the Spanish language only, while still another includes bi-lingual individuals who use both English and Spanish in everyday life. Some bi-lingual individuals may be most comfortable using their primary language. When information is presented predominantly in their secondary language, it may be helpful to have at least a part of that information also available in some format available in their primary language. Ideally, publicly accessible AEDs ideally should be usable by any of the individuals who may be available to act as a rescuer in a given location, whatever language or languages the individual uses.

### SUMMARY OF THE INVENTION

In accordance with the present invention, a method and apparatus is disclosed for providing a medical device that provides the user with instructions in two (or more) languages at the same time.

In one aspect of the invention, a medical device for patient treatment includes an audible medium giving user instructions in a first language and a visual medium giving user instructions in a second language. In an embodiment of the invention, the medical device is an external defibrillator.

In another aspect of the invention, the user instructions in a visual medium include text instructions in the second language. The user instructions in a visual medium may also further include diagrammatical representations of the text instructions.

In another aspect, of the invention, the visual medium is a print medium. The print medium may be a card. In an embodiment where the medical device includes a lid, the card may be carried under the lid.

In another aspect of the invention, the visual medium is an LCD display.

In another aspect of the invention, the audible medium includes an audio speaker.

In another aspect of the invention, an external defibrillator adapted to lead an operator through a sequence of operations to deliver a defibrillation shock to a patient, includes an audio speaker that delivers instructions to the operator in a first language and a visual medium that presents instructions to the operator in a second language. The visual medium may present text instructions in the second language. It may also present pictorial representations of the text instructions in proximity to the text instructions. In another embodiment, the visual medium may be a display screen on the external defibrillator.

In another aspect of the invention, a method for providing a user interface to an operator of a medical device includes providing instructions to the operator audibly in a first language and visually in a second language.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a medical device comprising a defibrillator in accordance with the present invention;

FIG. 2 is a schematic block diagram of several of the key components of the defibrillator shown in FIG. 1;

FIG. 3 depicts the defibrillator of FIG. 1 wherein a lid of the defibrillator is opened, revealing an electrode package having a handle previously hidden beneath the lid;

FIG. 4 depicts an operator of the defibrillator opening the electrode package by grasping and pulling the handle;

FIG. 5 depicts the operator removing defibrillation electrodes from the opened electrode package;

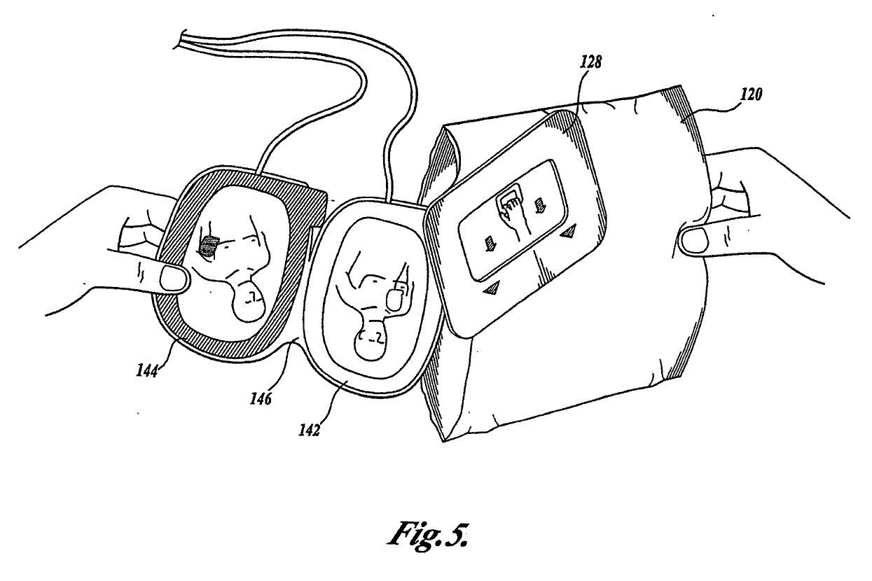

FIG. 6 depicts the defibrillator after the defibrillation electrodes have been removed from the electrode package, now discarded;

FIG. 7 depicts the operator removing an electrode pad from a liner sheet on which the defibrillation electrodes are removably adhered;

FIG. 8 depicts proper placement of the defibrillation electrodes on the exposed chest of a patient;

FIG. 9 depicts the defibrillator shown in FIG. 1 while in use by an operator;

FIG. 10 depicts a fully automatic defibrillator;

FIG. 11 depicts a reference card mounted on a surface portion of the defibrillator lid made visible to the operator when the lid is opened; and

FIG. 12 is a flow diagram depicting a prompting routine executed by the defibrillator to deliver visual and aural instructions to the operator.

### DETAILED DESCRIPTION OF THE PRESENT INVENTION

In accordance with the present invention, a user interface is provided for a portable medical device comprising user instructions presented in a first language in an audible medium, and in a second language in a visual medium. In this manner, the medical device may accommodate users who are fluent in either one of the two languages, and also users who have an understanding of the first language but are more comfortable having text prompts in a second language in which they are more skilled. Thus, an embodiment of the invention provides a bi-lingual user interface, i.e., an interface that prompts the user in two (or more) languages at the same time. For illustrative purposes, the invention is described in the context of a medical device which has a plurality of layered user interface components. Such a medical device is described in PCT Application Publication No. WO 03/097161, which is hereby incorporated by reference in its entirety. The user interface components are layered so as to become available to the operator of the device as they become necessary or appropriate during the operation of the device and treatment of the patient. Stated another way, the user interface components are layered to successively provide the operator with instructions and implements for operating the device and treating the patient. In the present description, the term “user interface component” is used to encompass any message and or/instruction sent to or received from the operator of the medical; device, any device component or accessory used to send or receive such messages/instructions, and any implement that is physically used by the operator for operation of the device or treatment of the patient.

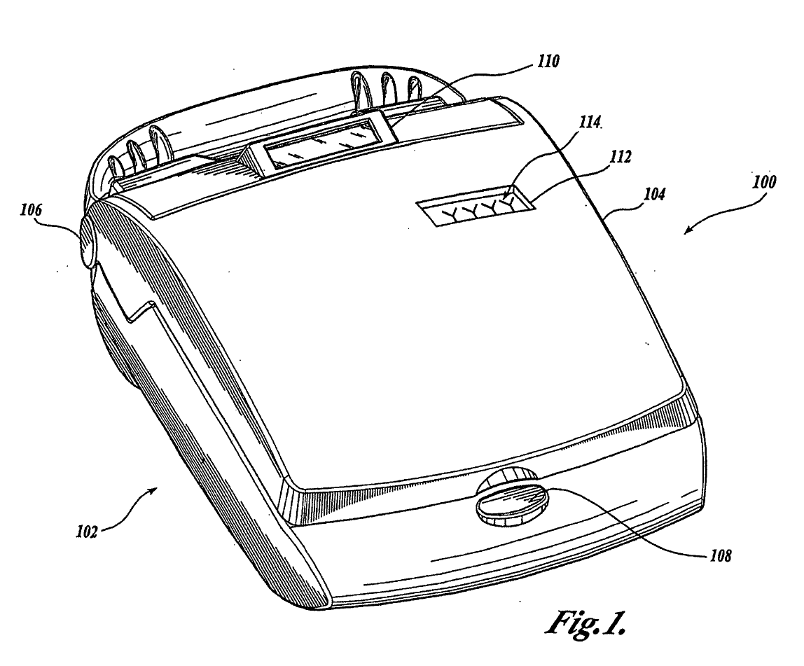

FIG. 1 illustrates a medical device embodied as a portable automated external defibrillator (AED) 100, suitable for incorporating the multilingual user interface of the present invention. Although a defibrillator is used to describe this embodiment, in light of this disclosure, those skilled in the art will be able to implement the present invention with other types of medical equipment without undue experimentation. Further, in the following description certain specific details are set forth in order to provide a thorough understanding of various embodiments of the present invention. One skilled in the art will understand, however, that the present invention may be practiced without these details. In other instances, well-known functions, features, and operations of AEDs have not been shown or described in detail in order to avoid unnecessarily obscuring the description of the various embodiments of the present invention.

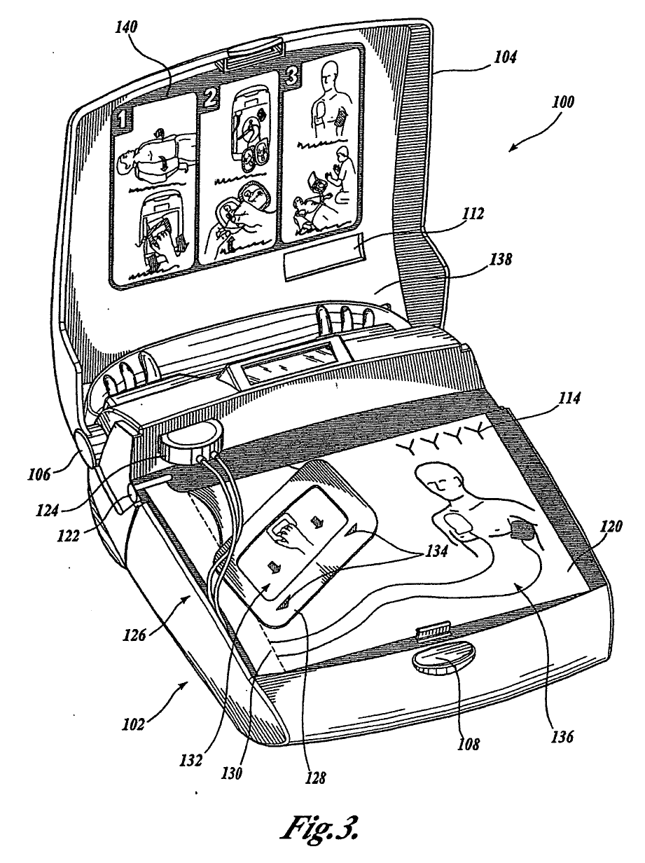

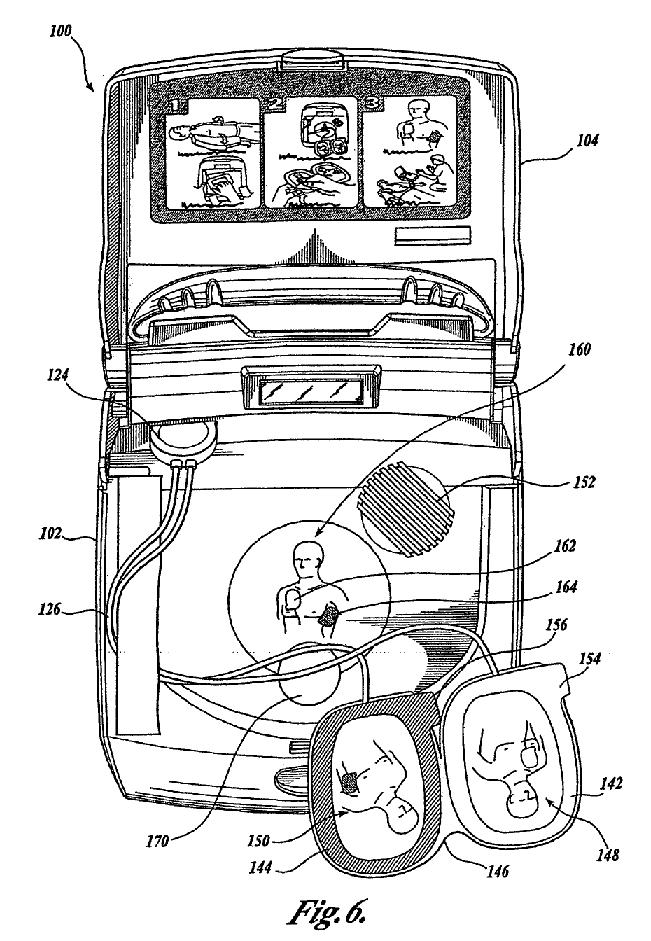

Returning to FIG. 1, an AED 100 incorporating a layered user interface formed is depicted. As depicted in the illustrated embodiment, the user interface components of the layered user interface may comprise an on/off actuator 108, a lid 104, an electrode package 120 (see FIG. 3) and a shock key 170 (see FIG. 6), as well as accompanying visual and/or audible instructions for operating the AED and for treating the patient. As will be appreciated from the following description, beginning with the on/off actuator 108, each successive user interface component will become available to the operator as it becomes necessary for use by or instruction to the operator.

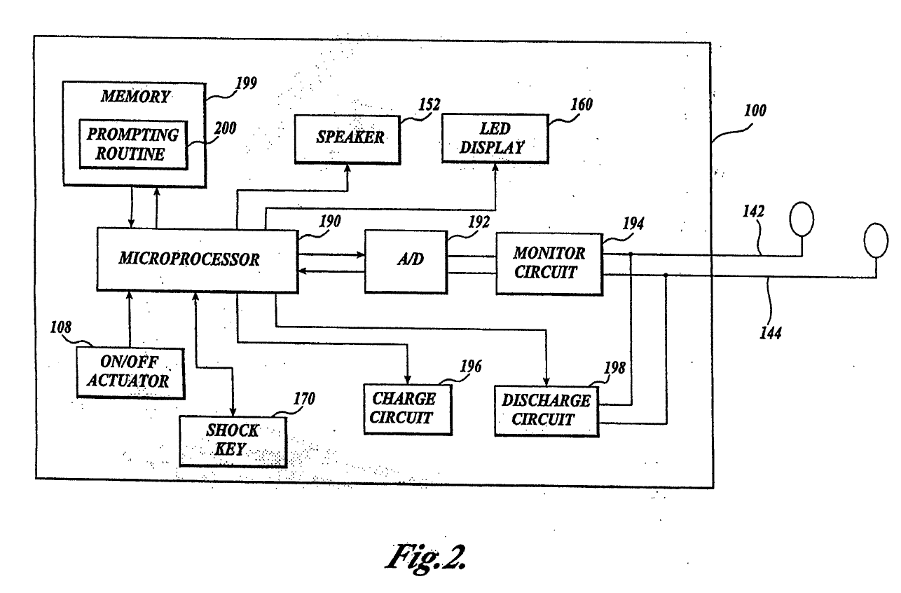

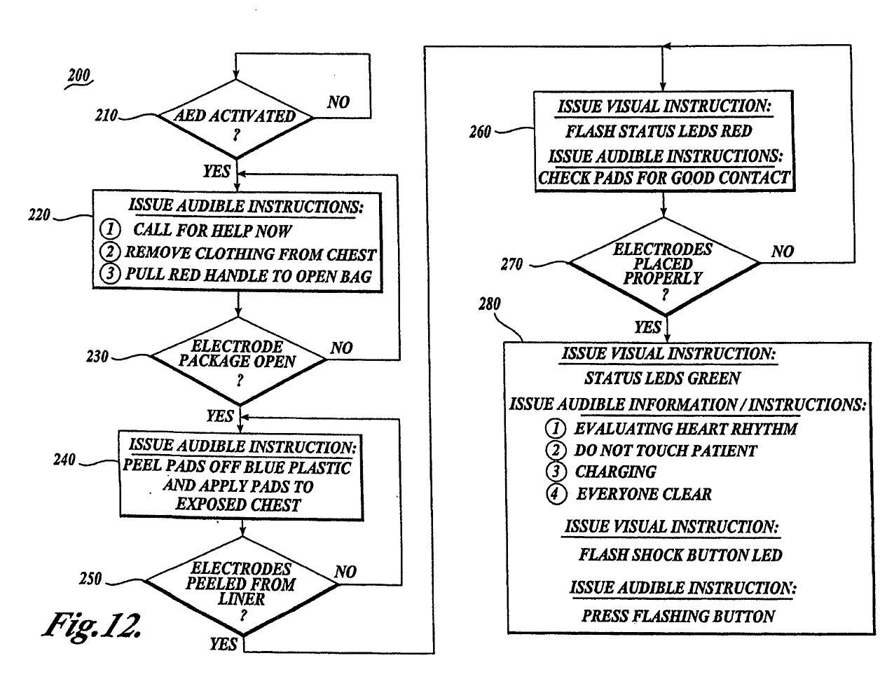

As shown in FIG. 1, the AED 100 includes a housing 102 containing the electronics necessary for the operation of the AED 100, as will be described in more detail below. As shown in more detail in FIG. 2, the AED 100 includes a microprocessor 190 which controls the operation of the AED 100. The microprocessor 190 is connected to an LCD display 160, a speaker 152, an on/off actuator 108, and a shock key 170. The microprocessor 190 is also connected to a memory 199 which stores a prompting routine 200 (see FIG. 12) formed in accordance with the present invention to generate visual instructions upon the display 160 and any accompanying aural instructions transmitted via the speaker 152. The visual instructions on the display 160 may include text in one language, while the aural instructions include voiced instructions in another language. In yet other embodiments of the present invention, the memory stores a voice recognition software module which allows the rescuer to operate the AED 100 and respond to visual and/or aural instructions via voice command rather than using the start and shock buttons. Such a module in combination with a microphone would then provide the rescuer with hands-free operation of the AED 100.

During defibrillation operation, the microprocessor 190 analyzes an electrocardiogram (ECG) of a patient using an automatic heart rhythm detection algorithm also stored in the memory 199 to identify whether the patient is experiencing a shockable heart rhythm, such as ventricular fibrillation. The detection algorithm executed by the microprocessor 190 in the actual embodiment of the present invention described herein is similar to that used in the LIFEPAK 500 defibrillator provided by Medtronic Emergency Response Systems Inc. of Redmond, Wash. Other known heart rhythm detection algorithms may also be used without departing from the scope of the present invention, such as those algorithms designed to comply with standards promulgated by the Association for the Advancement of Medical Instruments (AAMI). The ECG signals analyzed by the detection algorithm are collected by defibrillation electrodes 142, 144 and passed through a monitor circuit 194 to an analog-to-digital converter 192. The analog-to-digital converter 192 then passes the digitized signals to the microprocessor 190. If the microprocessor 190 detects a shockable rhythm, the microprocessor causes a charge circuit 196 to generate a current causing a storage capacitor (not shown) to charge in preparation for delivery of a defibrillation pulse. When the capacitor is fully charged, and delivery of the defibrillation pulse initiated, a discharge circuit 198 coupled to the microprocessor 190 and charge circuit 196 discharges the defibrillation pulse to the defibrillation electrodes 142, 144 for application of the defibrillation pulse to the patient.

Returning to FIG. 1, the AED housing 102 includes an on/off actuator 108 which is sized and colored so as to attract the operator's attention as the first action required to use the AED 100. For example, in one embodiment, the on/off actuator 108 is large in size (relative to its required mechanical function) and colored bright yellow to visually contrast with the substantially gray/black colored lid 104 of the AED 100. Though the on/off actuator 108 is illustrated to be in the form a button, the actuator may take various other shapes and forms, for example, a membrane, plate, bar, etc., as long as it is adapted to receive an operator's instruction to activate the AED 100. In one embodiment, the on/off actuator 108 is configured so that depressing it sequentially activates the AED 100 and opens the next user interface component, i.e., a lid 104. The lid 104 is pivotally coupled to the housing 102 at two pivot points 106 in a conventional manner, so that the lid 104 can be opened as shown in FIG. 3. Alternatively, movement of the lid 104 to an open position can be the event activating the AED 100. Indeed, one skilled in the art will appreciate that the presence of the on/off actuator 108 is optional, and the AED 100 could instead be activated by the operator opening the lid 104, or by another operator-initiated action. Activation of the medical device by any of these or other methods or systems may be referred to in the context of the present invention as an “activation layer” of the layered user interface.

FIG. 3 illustrates the AED 100 of FIG. 1 when the lid 104 is opened, bringing the operator to the next layer of user interface component that is appropriate for use at this point in the operation of the device and the treatment of the patient, i.e., opening the lid 104 brings the operator to an electrode package 120 positioned within the housing 102 beneath the lid 104. In one embodiment, the electrode package 120 is a bag attached to the housing 102 by an anchor pin 122. Contained within the electrode package 120 are a pair of defibrillation electrodes (not shown in FIG. 3) that are electrically coupled with monitoring and defibrillation circuitry inside the housing 102 by an electrode connector 124 and electrode wires 126.

As will be appreciated by those skilled in the defibrillator arts, once an AED is activated, the next step in its operation is typically to apply a pair of defibrillation electrodes to the patient's chest that are used to monitor the patient's heart rhythm and deliver a defibrillation pulse is necessary. Accordingly, in one embodiment of the present invention, the electrode package 120 is positioned beneath the lid 104 and sized so as to attract the operator's immediate attention as the next appropriate action to take in the operation of the device and treatment of the patient. To further intuitively guide the operator in the correct operation and application of the electrodes, the electrode package 120 includes a package opening member, such as handle 128, which the operator pulls to open the electrode package along a tear line 130 and release the defibrillation electrodes packaged therein. To further bring attention to the handle, the handle is configured and colored to be conspicuous to the operator. For example, in one embodiment the handle 128 is large in size (relative to its required mechanical function) and colored bright red to visually contrast with the substantially white colored electrode package 120. Also, the handle has a skew orientation—i.e., not aligned parallel with the sides of the substantially rectangular electrode package 120—which further visually attracts the operator's attention. Still further, the handle 128 itself may include diagrammatic arrows 134 indicating the direction the operator should pull the handle and the upper surface of the electrode package 120 may include a graphical diagram 132 depicting how the operator should grasp and pull the handle 128 in order to open the electrode package 120 (as well as a patient diagram 136 that depicts the appropriate placement of the defibrillation electrodes on the chest of a patient).

In addition to the size, configuration, color and placement of the electrode package 120 and the handle 128, the AED 100 may issue audible instructions to the operator upon opening of the lid 104 to pull the handle 128 to open the electrode package 120, as well as audible instructions to first call for help and remove clothing from the patient's chest.

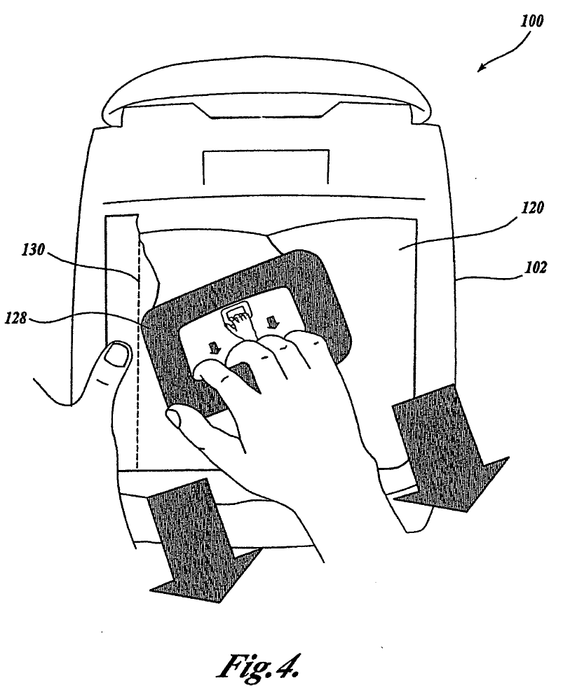

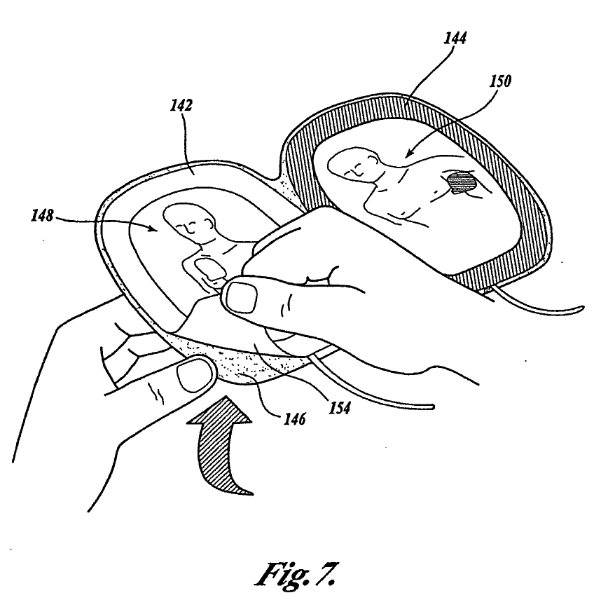

FIG. 4 depicts the operator pulling on the handle 128 in order to open the electrode package 120 along the tear line 130. FIGURE S then shows the operator removing the defibrillation electrodes 142, 144 (also commonly referred to as electrode pads) from the electrode package 120. Referring now to FIG. 6, the AED 100 is shown after the defibrillation electrodes 142, 144 have been removed from the opened electrode package 120 (which the operator has discarded or otherwise set aside, and is not shown in FIG. 6). The operator is now presented with the next layer of user interface component, namely, the defibrillation electrodes 142, 144 themselves. In the embodiment shown in FIG. 7, the defibrillation electrodes 142, 144 are positioned on a single pad liner 146 of contrasting color to that of the electrodes. (Those skilled in the art will appreciate that the defibrillation electrodes could instead be positioned on separate liners or in other suitable configurations.) For example, the defibrillation electrodes 142 and 144 may have respectively colored boundaries of yellow and red, with the liner 146 being blue-colored plastic. It has been found that lay persons unfamiliar with the use of AEDs or medical devices often do not realize that defibrillation electrodes include a layer of gel covered by a liner that must be removed in order to reveal the gel and affix the electrode to the patient. The different colors of the electrodes and the liner, along with the disposition of the defibrillation electrodes 142, 144 together on a single liner 146, intuitively emphasize to the operator that the defibrillation electrodes must be separated from one another and from the liner in order to be applied. To further guide the operator in releasing the liner from the electrodes, each of the defibrillation electrodes 142 and 144 has a respective one of tabs 154 and 156 (see also FIG. 6), which the operator grasps and pulls in order to remove the defibrillation electrodes from the liner 146. The tabs 154, 156 may include diagrammatic arrows that visually indicate to the operator to pull the tabs. In addition, the tabs 154, 156 are large and protrude beyond the boundary of the liner 146, so as to be visually obvious to the operator.

To further guide the operator in the placement of the electrodes once separated from one another and removed from the liner 146, the defibrillation electrodes 142 and 144 include pad placement diagrams 148 and 150, respectively, which illustrate for the operator the proper location for each electrode on the patient. In one embodiment, each pad placement diagram depicts the proper location of only its corresponding pad, it does not depict both pads. Proper placement of each electrode is further intuitively encouraged by placing the defibrillator electrode 142 intended for placement on the left side of the patient (from the operator's perspective) on the left side of the liner 146, and placing the defibrillator electrode 144 intended for placement of the right side of the patient on the right side of the liner 146. Proper placement is encouraged further by coloring the boundaries of the defibrillation electrodes 142 and 144 differently (e.g., yellow and red as mentioned above) and by using corresponding colors in the pad placement diagrams 148 and 150.

In addition to the size, configuration, color and placement of the defibrillation electrodes 142 and 144 and the liner 146, the AED 100 may issue additional audible instructions to the operator via an audio speaker 152 to remove each of the defibrillation electrodes 142, 144 from the liner 146 and to then apply the defibrillation electrodes to the exposed chest of the patient.

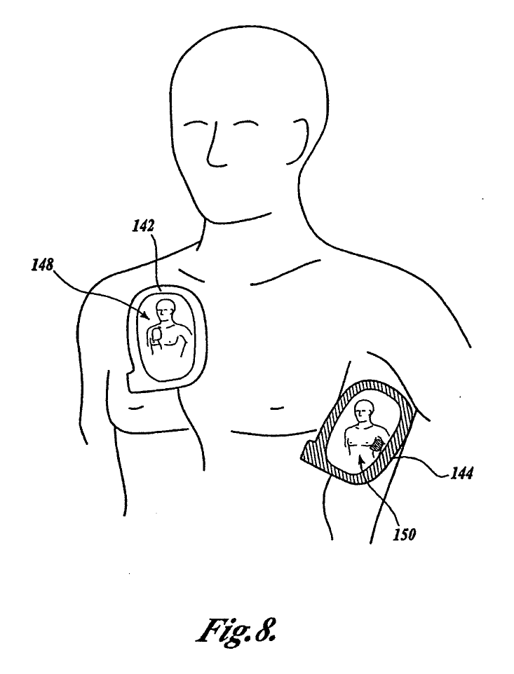

FIG. 8 depicts the proper placement of the defibrillation electrodes 142, 144 on the exposed chest of the patient, consistent with the colors of the defibrillation electrodes, the positioning of the defibrillation electrodes on the liner, the pad placement diagrams 148, 150 on the defibrillation electrodes, and the audible instructions. The deployment of the electrode package 120 and the defibrillation electrodes 142, 144 as, for example, described above, maybe referred to in the context of the present invention as an “electrode application layer” of the layered user interface.

Returning to FIG. 6, once the electrode package 120 is removed from the AED 100, the next layer of user interface component made available to the operator is the shock key 170 and an electrode status display 160 that depicts the proper positioning of the defibrillation electrodes 142, 144 on the patient. As will be appreciated from the description below, this layer of user interface component intuitively directs the user to what may become the next appropriate action in the operation of the device and treatment of the patient, namely, depressing the shock key 170 to initiate delivery of a defibrillation pulse to the patient if the electrodes are properly attached and the device detects the presence of a shockable heart rhythm.

Returning to the electrode status display 160, the diagram includes electrode indicators 162, 164 that indicate whether the defibrillation electrodes have been placed on the patient. The electrode indicators 162, 164 can include visual display elements, such as light-emitting diodes, that produce first and second visual signals. For example, the electrode indicators 162 and 164 will display a red light if one of the defibrillation electrodes 142 and 144 has not yet been or is not attached to the patient. Conversely, once the corresponding defibrillation electrode is properly placed on the patient (i.e., the liner has been removed, the electrode attached to the bare-chested patient, and impedance has been detected), the electrode indicators 162, 164 then display a green light.

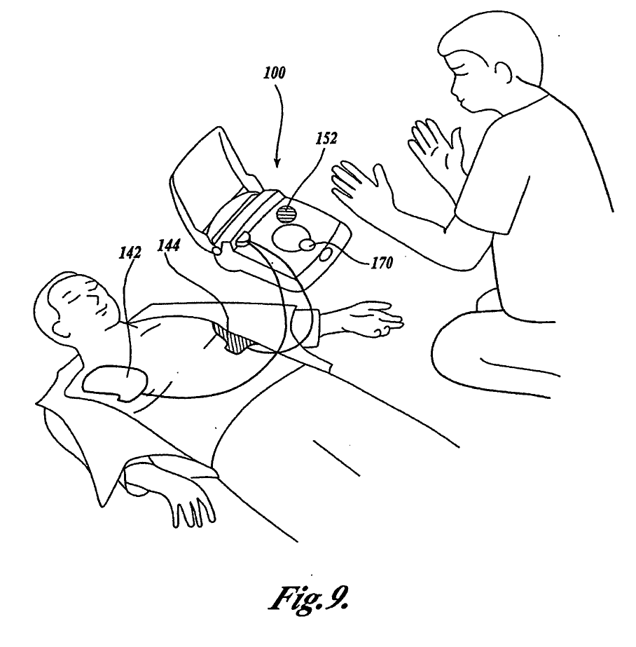

Once the electrodes are properly placed on the patient, the AED 100 begins collecting electrocardiogram (“ECG”) signals from the patient and analyzing them for a shockable rhythm. FIG. 9 depicts the operator awaiting further device operation and/or treatment instructions from the AED 100. During this time, the AED 100 may issue additional audible instructions, such as instructions to check the firm adhesion of defibrillation electrodes 142, 144 to the patient, CPR instructions, emergency notification instructions, etc.

If a shockable rhythm is detected, the operator's attention is immediately drawn to the shock key 170 (which is only made available to the operator after the electrode package 120 has been opened and removed from the housing 102) via further visual and/or audible indications. For example, the shock key 170 may be sized, colored and labeled such that it draws the attention of the operator and indicates its function to the operator. For example, the shock key 170 shown in FIG. 6 is prominently sized, centrally placed, contrastingly colored (e.g., red), and includes a diagram depicting an electric shock delivered to a heart. When a shockable rhythm is detected, the shock key 170 may also flash or issue some other suitable visual signal so as to indicate to the operator that he or she can depress the shock key 170 to initiate delivery of a defibrillation pulse to the patient. Additionally, the AED 100 may issue audible instructions to the operator via the audio speaker 152 to depress the shock key 170. Accordingly, it can be appreciated from the above description, that the operator is automatically and intuitively guided by the layered user interface of the present invention from the on/off actuator 108 to the shock key 170, to ultimately initiate delivery of a defibrillation pulse to the patient.

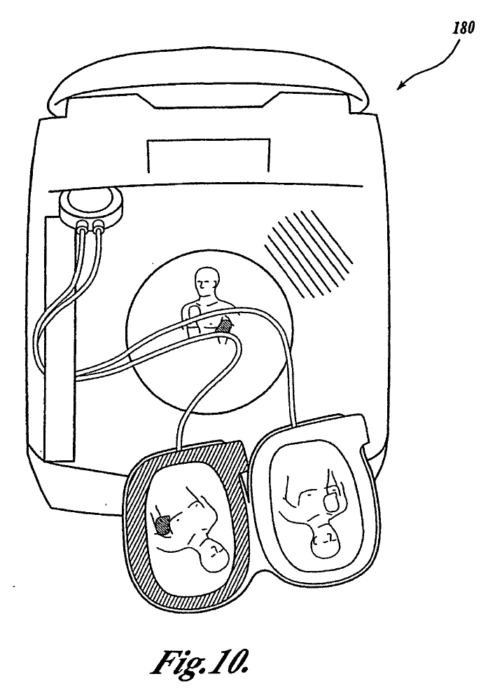

It will be appreciated, however, that in another embodiment of the present invention, the AED 100 can be a fully automatic defibrillator (rather than a semi automatic defibrillator), meaning that the device automatically initiates delivery of a defibrillation pulse to a patient upon detecting a shockable heart rhythm. Accordingly, operator initiation is not required and the shock key 170 is eliminated. A fully automatic AED 180 is shown in FIG. 10, in which no shock key is provided, and in which the AED itself initiates delivery of the defibrillation pulse. The visual and/or audible instructions provided to guide the operator through the delivery of the defibrillation pulse, as well as the shock key 170 if the AED is semi-automatic, may be referred to in the context of the present invention as a “defibrillation pulse delivery layer” of the layered user interface.

Returning to FIG. 3, given the difficulty a lay person may have opening the electrode package 120, applying the defibrillation electrodes to the patient and operating the AED, the AED 100 may also include another layer of user interface component that is made available to the operator simultaneously with the electrode package 120 when the lid 104is opened. More specifically, a reference card 140 may be mounted to a bottom surface 138 of the lid 104 that graphically depicts a sequence of the basic instructions to be followed by the operator during use of the AED, and also includes text instructions. Where the audible prompts and instructions provided by the AED are in a first language, the text on the reference card is in a second language. For example, in the illustrated embodiment, the audible voice instructions provided by the AED may be in English and the text instructions may be in Spanish.

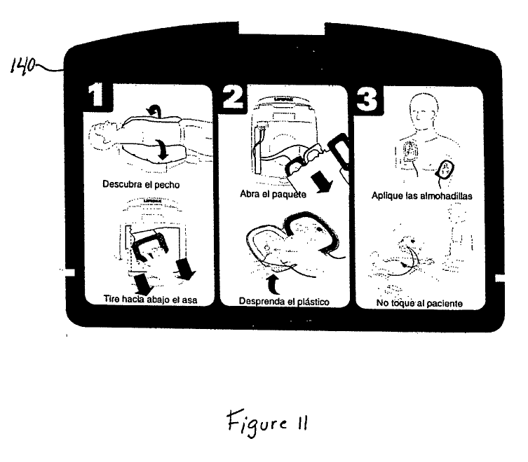

FIG. 11 shows a close-up view of the reference card 140 for such an embodiment. The illustrated embodiment of the reference card 140 depicts the following basic instructions: (1) remove the patient's clothing and pull the handle on the electrode package; (2) remove the electrodes from the package and peel them off the liner, and (3) apply the electrodes to the patient's chest, and stand clear. These instructions are illustrated diagrammatically and are printed in text in the Spanish language. (The description of the instructions given above is a paraphrase and not intended to be an exact translation of the Spanish text. The text is represented only schematically in FIGS. 3 and 6). The txt of the visual medium instructions may be an exact translation of the audible instructions, or may be a paraphrase or abridged version. Although text instructions in a printed medium have been illustrated, it will be understood that text instructions or prompts in the second language may be provided in other kinds of visual media, such as being applied to or embossed on the device itself, or on the display screen 160 on the medical device. The display screen may be, for example, an LCD or CRT display. The text instructions or prompts may include substantially all of the information given in the audible instructions. Alternatively, the text instructions may include a subset of the information given in the audible instructions. This may be useful in a setting where the text instructions are intended to serve as an aid to a bi-lingual user, reinforcing or clarifying the information presented by the aural voice instructions.

Where a display screen is used to provide the text prompts in the second language, the display may scroll through the text prompts, with each particular text prompt displayed simultaneously with the issuance of the corresponding voice prompt, or a group of text prompts may be displayed at the same time on the screen. Text instructions in additional languages could also be provided by including additional cards with text in each of the additional languages with the medical device, or by provide instructions in additional languages in proximity to the text in the second language. On a reference card, for example, text in the second a third language could be both be printed on the card, with instructions for each picture appearing in two or more languages under that picture (different languages printed on separate lines). Alternatively, instructions in a third language could be printed on back of the card, with some indicia appearing on its front side to inform the user of the third language instructions available on the flip side of the card. Where a display is used, the text in the additional languages could be displayed simultaneously with the text in the second language, or the user could be given the option to choose which language he wants displayed, through a user interface such as, for example, a push button which results in language choices being scrolled through until the desired choice is reached.

In an embodiment of the invention, substantially all of the instructions provided in the form of audible voice prompts in the first language are also provided in the visual medium in the second language. The illustrated embodiment also provides the user guidance in formats which do not use words. These include visual media such as pictorial and diagrammatic representations of actions to be taken, attention-getting colors, and the like. Audible prompts may also include non-verbal prompts such as tones, for example. These additional non-verbal guidance features and prompts further aid to make the device one which may be comfortably and competently used by users who are fluent in either one of the first or second languages.

Accordingly, the operator is given an immediate and always visible idea of what steps must be taken to operate the device and treat the patient. Those skilled in the art will appreciate, however, that the reference card 140 may include any instructions, diagrams, text, etc. deemed desirable by the manufacturer.

In one embodiment of the present invention, the operator is further guided through the layered user interface in the operation of the device and treatment of the patient by a series of audible instructions or voice prompts in a first language provided by the AED 100 to the operator via an audio speaker 152 (see FIG. 6), along with electrically driven visual signals, such as the electrode indicators 162, 164 and flashing shock key 170. Corresponding text prompts in a second language can be provided on the reference card 140, or on additional cards provided with the device, or may be printed or embossed on the AED housing itself or on other elements that are part of the AED. One skilled in the art will understand that any of a wide variety of combinations of hardware circuitry and software programming can be used to detect or otherwise time the sequence of operator actions and then provide the corresponding signals to the audio speaker 152 and driven visual elements.

Particular details of such circuitry and software need not be disclosed for one skilled in the art to understand the teachings of the present invention. However, one example of such circuitry and software as implemented in an AED is described in commonly assigned U.S. Pat. No. 6,334,070, entitled “Visual and Aural User Interface for an Automated External Defibrillator,” issued Dec. 25, 2001, and specifically incorporated herein by reference.

Referring to FIG. 12, a flow diagram is presented to depict the sequence of audible and electrically driven visual instructions issued by the AED 100 for the scenario in which a defibrillation shock is actually delivered. A prompting routine 200 is executed by the AED 100, and includes issuing audible instructions via the audio speaker 152 and electrically driven visual instructions via the electrode indicators 162, 164 and flashing shock key 170. The routine 200 begins in a decision block 210 testing whether the AED 100 has been activated. Once the condition of block 210 is met, the routine 200 continues to block 220, in which the AED 100 issues audible instructions to the operator concerning calling for help, removing clothing to expose the patient's chest, and opening the electrode package 120. The routine 200 continues with a decision block 230 testing whether the electrode package 120 has been opened. If not, the routine 200 returns to block 220.

Once the condition of decision block 230 is met, the routine 200 then continues to block 240, in which the AED 100 issues audible instructions concerning removal of the defibrillation electrodes 142, 144 from the electrode package 120 and removal of the electrodes from the liner 146. The routine 200 then continues to a decision block 250 testing whether the defibrillation electrodes 142, 144 have been removed from the liner 146. If not, the routine 200 returns to block 240 and the appropriate audible instructions are repeated.

Once the condition of decision block 250 is met, the routine 200 then continues with a third instructional step 260, in which the AED 100 issues audible instructions concerning placement of the defibrillation electrodes 142, 144 on the patient's chest and lights up the LEDs 162, 164 of the electrode status display 160 accordingly. The routine 200 continues to a decision block 270 and tests whether the defibrillation electrodes 142, 144 have been properly placed on the patient. If not, the routine 200 returns to block 260 to repeat the appropriate visual and aural instructions to the operator.

Once the condition of decision block 270 is met, the routine 200 continues to block 280, in which the AED 100 issues visual information confirming the proper placement of the defibrillation electrodes 142, 144 (i.e., lights the LEDs of the electrode status display 160 green) and audible information concerning evaluation of the patient's heart rhythm and preparations for delivering a defibrillation pulse. The AED 100 then issues visual instructions (e.g., flashing shock key 170) and audible instructions to the operator to press the shock key 170 and initiate delivery of the defibrillation pulse to the patient.

Those skilled in the art will appreciate that a number of well-known operations are not presented in the flow diagram of FIG. 12, such as instructions relating to patient movement (if detected), decisions by the AED diagnostic circuitry not to shock, instructions relating to CPR, and the like. Such AED operations are described in U.S. Pat. No. 6,334,070, already incorporated herein by reference. Those skilled in the art will further appreciate that various operations can be omitted from the flow diagram of FIG. 12 and performed and/or input by an operator or other device, or substituted with a time-out function without departing from the spirit and scope of the present invention.

It will be appreciated by those skilled in the art that the audible instructions and text instructions used in a medical device may vary in content or scope from what is described above, may omit some of the instructions described above or include other instructions not described above, without departing from the spirit or scope of the present invention.

While certain embodiments of the invention have been illustrated and described, those skilled in the art will appreciate that various changes can be made without departing from the spirit and scope of the invention. Additional layers of user interface components may be added as appropriate to assist in the operation of the device, treatment of the patient or perhaps the maintenance of the device. For example, as illustrated in FIGS. 1 and 3, the AED 100 may include a readiness display 110 that includes various symbols indicating the status of the AED, such as indicating its readiness for use, the need to replace a battery unit, the need for inspection or repair, or other indication as would be understood by those skilled in the art. The AED 100 may also include a window 112 in the lid 1 04 through which an electrode expiration date 114 stamped on the upper surface of the electrode package 120 (see FIG. 3) can be seen by the operator when the lid is closed. Together these components may be referred to in the context of the present invention as a “status layer” of the user interface.

I claim:

1. A medical device for patient treatment comprising an audible medium giving user instructions in a first language and a visual medium giving user instructions in a second language.

2. The medical device of claim 1, wherein the user instructions in a visual medium include text instructions in said second language.

3. The medical device of claim 2, wherein the user instructions in a visual medium further includes diagrammatical representations of the text instructions.

4. The medical device of claim 2, wherein the visual medium is a print medium.

5. The medical device of claim 2, wherein the visual medium is an LCD display.

6. The medical device of claim 1, wherein the medical device is an external defibrillator.

7. The medical device of claim 2 wherein said audible medium includes an audio speaker.

8. The medical device of claim 3 wherein said medical device includes a lid and said print medium includes a printed card carried under said lid.

9. The medical device of claim 6, wherein the user instructions include instructions for application of electrodes to the patient.

10. An external defibrillator adapted to lead an operator through a sequence of operations to deliver a defibrillation shock to a patient, comprising:
an audio speaker which delivers instructions to the operator in a first language;
a visual medium which presents instructions to the operator in a second language.

11. The external defibrillator of claim 10 wherein the visual medium presents text instructions in said second language.

12. The external defibrillator of claim 10, wherein the visual medium presents pictorial representations of the text instructions in proximity to the text instructions.

13. The external defibrillator of claim 10, wherein the visual medium is a print medium.

14. The external defibrillator of claim 10, wherein the visual medium is a display screen on the external defibrillator.

15. The external defibrillator of claim 10 further comprising a lid and wherein said print medium includes a card carried under said lid.

16. The external defibrillator of claim 10 wherein substantially all of the instructions presented in the first language are presented in the second language.

17. A method for providing a user interface to an operator of the medical device of claim 1, wherein the medical device is an external defibrillator, the method comprising: providing instructions to the operator audibly in a first language and visually in a second language.

18. The method of claim 17 further comprising providing non-verbal audible prompts to the user.

19. The method of claim 18 further comprising providing non-textual visual prompts to the user.

20. The method of claim 17 further comprising providing instructions to the user visually in at least one language in addition to the second language.
